(19) United States
(12) Patent Application Publication
(10) Pub. No.: US 2006/0215206 A1
(43) Pub. Date: Sep. 28, 2006

(54) Image forming device and storage medium which stores an insufficient recording agent alert program of the image forming device

(75) Inventors: Takashi Tamura, Osaka (JP); Akifumi Seto, Osaka (JP); Isao Kohda, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 10/907,188

(22) Filed: Mar. 24, 2005

(51) Int. Cl. G06K 15/00

(52) U.S. Cl. 358/1.14

(57) ABSTRACT

An image forming device is disclosed that includes a recording agent quantity detection means that detects whether there is an insufficient amount of recording agent for image formation, a display means that informs a user that there is insufficient recording agent, and a display control means that displays on at least a portion of the display means a color that corresponds to the color of the recording agent whose insufficiency was detected with the recording agent quantity detection means.

### BACKGROUND OF THE INVENTION

1. Field of the Invention

The present invention relates to an image forming device and a storage medium which stores an insufficient recording agent alert program of the image forming device, and more particularly relates to an image forming device and a storage medium which stores an insufficient recording agent alert program of the image forming device that will issue an alert when there is an insufficient amount of recording agent such as toner, ink, or the like for image formation.

2. Background Information

Copy machines which are capable of printing in color have become more common in the market in recent years. These types of machines employ 4 color (cyan, magenta, yellow, and black) recording agents such as toner, ink, or the like to form images. The 4 color recording agents are combined together during image transfer in order to achieve color printing.

Because there is only one type of recording agent in monochrome copy machines, an insufficient recording agent alert will be complete when a guidance message such as “low toner” is displayed at the point in which there is little or no recording agent remaining in the copying machine. However, because there are 4 types of recording agents in color copy machines, when the same guidance message as that used in monochrome copy machines is used, a user cannot immediately identify which recording agent must be replenished, and thus cannot smoothly perform the task of replenishing the recording agents.

Accordingly, an insufficient recording agent alert display has been proposed in the past which allows a user to immediately identify the recording agent that must be replenished, by means of a guidance message which adds the first letter of the name of the color of the recording agent to be replenished to the end of the message, e.g., “low toner [C]”. See for example Japanese Unexamined Patent Application Publication No. 2000-284653.

However, with an insufficient recording agent alert display that adds the first letter of the name of the color of the recording agent, it is difficult for a user to immediately identify the recording agent to the replenished because the names of colors such as cyan, magenta, etc. are not widely recognized.

An object of the present invention is to provide both an image forming device, and a storage medium that stores an insufficient recording agent alert program for the image forming device which can display a highly visible insufficient recording agent alert on a color display of the image forming device, and which allows a user to immediately recognize the recording agent that must be replenished.

### SUMMARY OF THE INVENTION

The image forming device of the present invention includes a recording agent quantity detection means that will detect whether there is an insufficient quantity of recording agent for image formation, and a display means that will notify a user when the recording agent quantity detection means determines that there is an insufficient quantity of recording agent for image formation.

The image forming device of the present invention also includes a display control means that will display, on at least a portion of the display means, a color that corresponds to the color of the recording agent determined to have an insufficient quantity by the recording agent quantity detection means.

Thus, in the event that there is an insufficient amount of recording agent for image formation, a highly visible insufficient recording agent alert display can be performed by displaying a color that corresponds to the color of the recording agent that must be replenished on at least a portion of the display screen, thus allowing a user to immediately identify the recording agent that must be replenished.

In addition, when the recording agent quantity detection means detects that there is an insufficient quantity of a plurality of recording agents, the display control means will display colors that correspond to the colors of the insufficient recording agents on at least a portion of the display means.

Thus, because colors will be displayed which correspond to the colors of the recording agents that must be replenished, the task of replenishing the recording agents can be performed more smoothly.

Furthermore, when the recording agent quantity detection means detects that there is an insufficient quantity of a plurality of recording agents, the display control means will sequentially display for a predetermined period of time colors that corresponds to each color of the insufficient recording agents on at least a portion of the display means.

Thus, because colors are sequentially displayed that correspond to the colors of the recording agents that must be replenished, this will be highly visible to the user, and will allow the task of replenishing the recording agents to proceed more smoothly.

In addition, when the recording agent quantity detection means detects that there is an insufficient quantity of a plurality of recording agents, the display control means will display colors that correspond to each color of the recording agents in a predetermined ranked order on at least a portion of the display means.

Thus, by ranking and displaying the plurality of recording agent colors in accordance with their frequency of use, one can more efficiently replenish the recording agents.

Furthermore, the image forming device of the present invention may further include a display method setting means that will changeably set the predetermined ranked order.

Thus, because a user can change the ranked order, one can more efficiently replenish the recording agents.

In addition, a storage medium that stores an insufficient recording agent alert program of the image forming device of the present invention is disclosed. The image forming device includes a recording agent quantity detection means that detects whether there is an insufficient quantity of recording agent for image formation, and a display means that will notify a user when the recording agent quantity detection means determines that there is an insufficient quantity of recording agent for image formation. The insufficient recording agent alert program will cause a processor of the image forming device to execute a display control step which displays, on at least a portion of the display means of the image forming device, a color that corresponds to the color of the recording agent whose quantity was determined to be insufficient in a recording agent quantity detection step.

Thus, in the event that there is an insufficient amount of recording agent for image formation, by displaying a color that corresponds to the color of the recording agent that must be replenished on at least a portion of the display screen, a highly visible insufficient recording agent alert can be displayed, and a user can immediately identify the recording agent that must be replenished.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram is a block diagram showing an outline of the functions of an image forming device of the present invention;

FIG. 2 is a flowchart of a first embodiment of the image forming device of the present invention;

FIG. 3 is a flowchart of a second embodiment of the image forming device of the present invention;

FIG. 4 is a cross-sectional view of the image forming device of the present invention;

FIG. 5 shows a display means of the image forming device of the present invention; and

FIG. 6 shows an insufficient recording agent alert being displayed on the display means of the image forming device of the present invention.

### DETAILED DESCRIPTION OF THE INVENTION

Embodiments of the present invention will be described below in detail with reference to the figures.

### First Embodiment

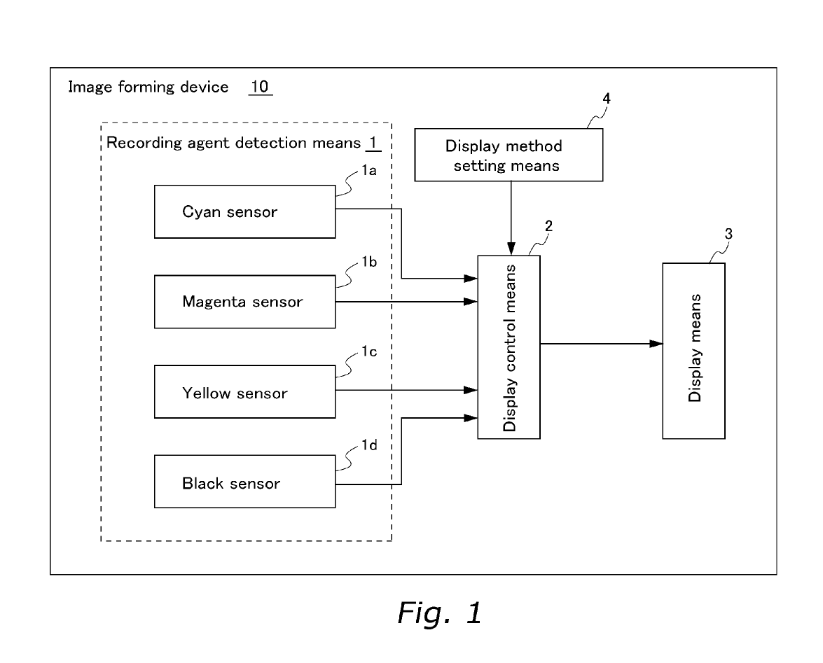

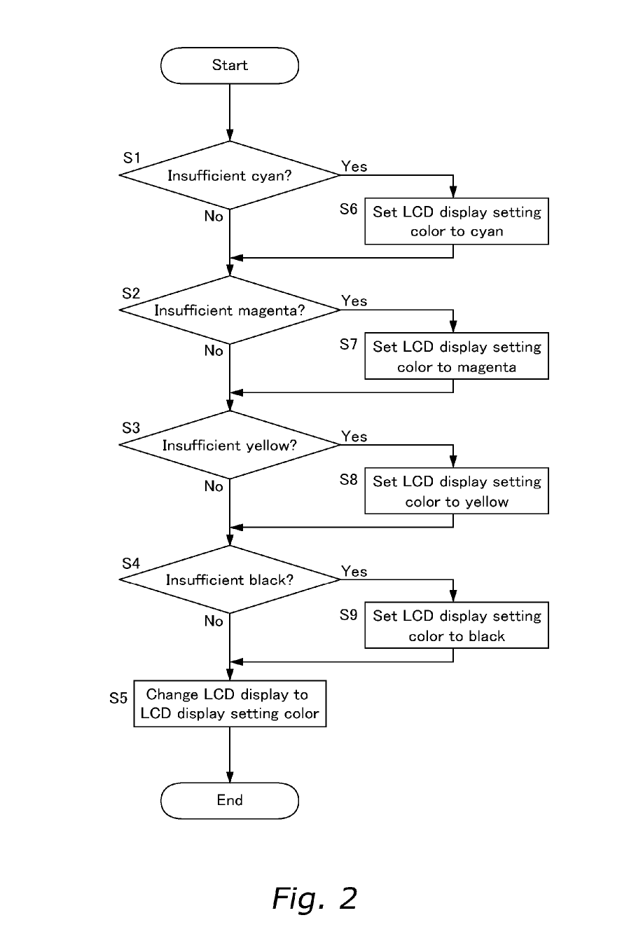

FIG. 1 is a block diagram showing an outline of the functions of an image forming device of the present invention, and FIG. 2 is a flowchart showing the steps in an insufficient recording agent alert display process of the image forming device of the present invention.

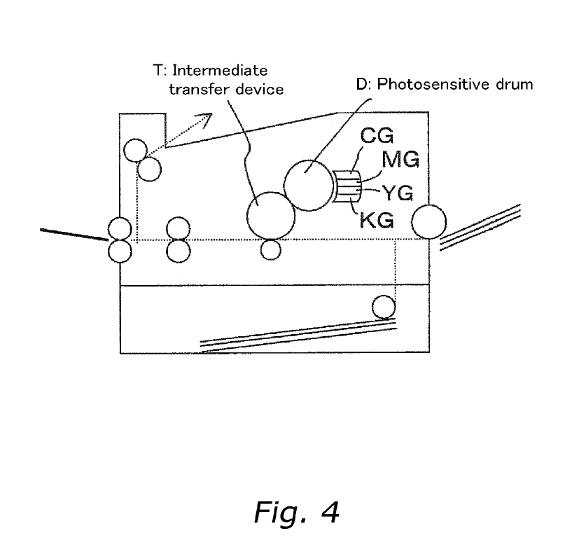

Image formation is performed as described below, particularly when the image forming device shown in cross-section in FIG. 4 is employed. The image forming device of FIG. 4 includes a photosensitive drum D having developing devices CG, MG, YG, KG arranged around the periphery thereof that correspond to the colors cyan (C), magenta (M), yellow (Y), and black (K), and an intermediate transfer device T.

First, cyan toner that corresponds to the print data is placed on the surface of the photosensitive drum D, and then a toner image composed of only cyan is transferred onto the intermediate transfer device T. Next, magenta toner that corresponds to the print data is placed on the surface of the photosensitive drum D, and then a toner image composed of only magenta is overlaid onto the previous cyan toner image on the intermediate transfer device T. The yellow and black toners that correspond to the print image are likewise sequentially placed onto the surface of the photosensitive drum D, and are then overlaid onto the toner image previously transferred to the intermediate transfer device T. In this way, a toner image composed of cyan, magenta, yellow, and black will be formed on the intermediate transfer device T. Note that the color sequence used to form an image on the intermediate transfer device T is not necessarily cyan, magenta, yellow, and black, and may be any sequence. In addition, the recording agent used for image formation is not limited to toner, and may by ink or the like.

A recording agent quantity detection means 1 (a cyan sensor 1a, a magenta sensor 1b, a yellow sensor 1c, and a black sensor 1d) is arranged in the developing devices CG, MG, YG, and KG, detects the amount of toner remaining inside each developing device, and communicates the detection results to a display control means 2 arranged in the image forming device 10. Here, a variety of conventionally known detection means can be used as the recording agent quantity detection means 1, including means which employ a piezo element, which use the optical reflectance and/or optical transmission of the toner, which detect the torque of a toner transport member, or which use an alternating voltage that is applied as a developing bias, and use the change in capacitance between each developer (not shown in the figures) and a detection conductor (antenna conductor) (not shown in the figures) arranged inside each developing device.

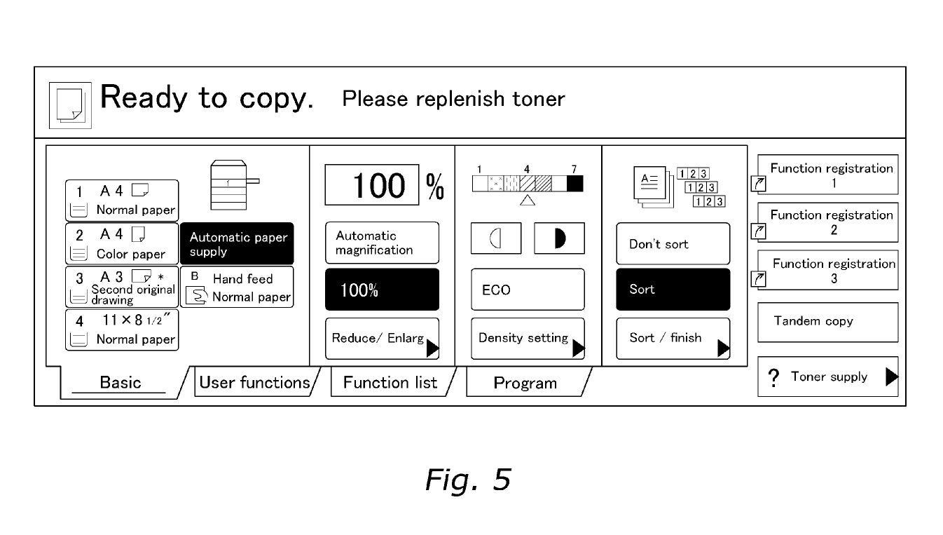

The color of toner that is determined to have an insufficient quantity will be displayed, as shown in FIG. 5, on a display means 3 such as a liquid crystal display and in the color of the toner that is determined to be insufficient. In the present embodiment, when there are a plurality of toners that are determined to have an insufficient quantity, a setting will be performed in a display method setting means 4 that will display all of the colors of the toners having insufficient quantities. The operation of the image forming device of the present invention will be described below with reference FIG. 2, and is based on the assumption that the amounts of the magenta and yellow toners remaining in the image forming device 10 are insufficient.

The cyan sensor 1a will determine whether or not the amount of cyan toner remaining is insufficient (S1), and if there is an insufficient amount of cyan toner, the cyan sensor 1a will communicate this fact to the display control means 2. The display control means 2 stores the color of the insufficient toner as the color that will be displayed on the LCD, i.e., as the LCD display setting color (S6). However, here there is sufficient cyan toner, and thus the process will proceed to Step S2.

The magenta sensor 1b will determine whether or not the amount of magenta toner remaining is insufficient (S2). Here, the amount of magenta toner remaining is insufficient, and thus the magenta sensor 1b will communicate this fact to the display control means 2. The display control means 2 will store the color of the insufficient magenta toner as the LCD display setting color that will be displayed on the LCD (S7).

The yellow sensor 1c will determine whether or not the amount of yellow toner remaining is insufficient (S3). Here, the amount of yellow toner remaining is insufficient, and thus the yellow sensor 1c will communicate this fact to the display control means 2. The display control means 2 will store the color of the insufficient yellow toner as the LCD display setting color that will be displayed on the LCD (S8).

The black sensor 1d will determine whether or not the amount of black toner remaining is insufficient (S4), and if the amount of black toner remaining is determined to be insufficient, the black sensor 1d will communicate this fact to the display control means 2. The display control means 2 stores the color of the insufficient toner as the color that will be displayed on the LCD, i.e., as the LCD display setting color (S9). However, here there is a sufficient amount of black toner remaining, and thus the process will proceed to Step S5.

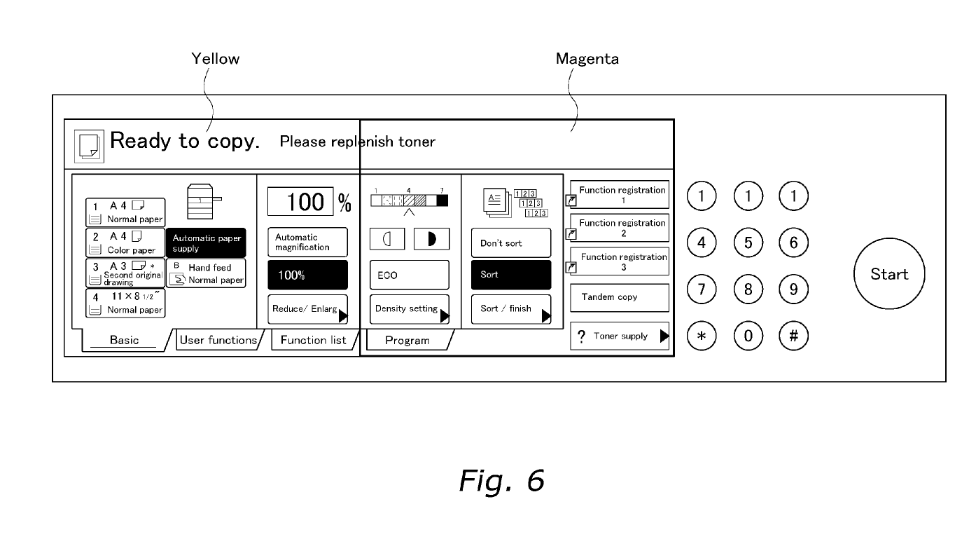

In Step S5, the display control means 2 will, as shown in FIG. 6, display in a split screen on the display means 3 (LCD) the magenta and yellow that were stored as the LCD display setting colors. This will indicate to the user that there is an insufficient amount of magenta and yellow toner for image formation.

Thus, in the event that there is an insufficient amount of recording agent for image formation, by displaying the color of the recording agent that must be replenished on at least a portion of display screen, a highly visible insufficient recording agent alert display can be performed, and a user can immediately identify the recording agent that must be replenished.

A user will recognize the magenta and yellow display, and can perform the task of replenishing the magenta and yellow toners.

### Second Embodiment

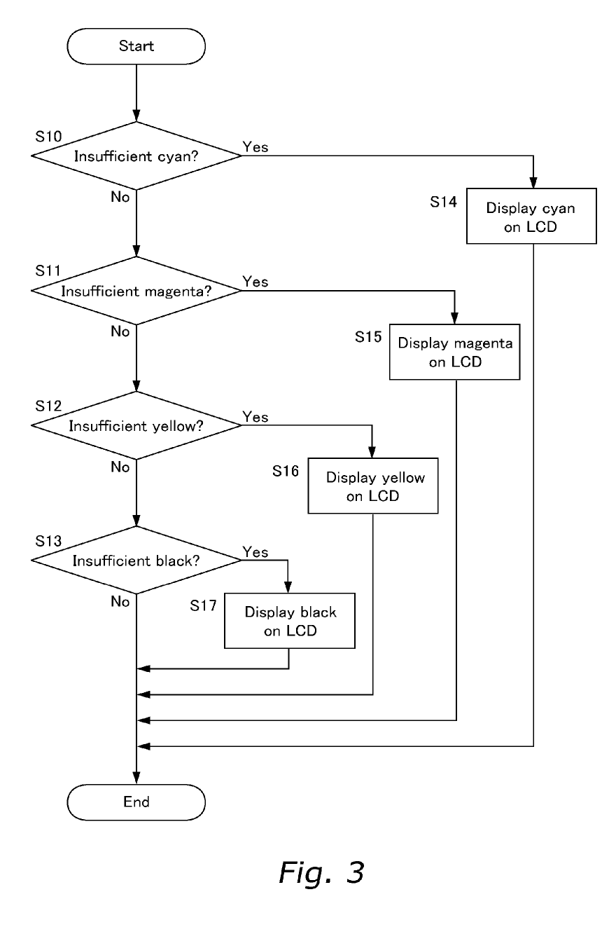

FIG. 3 is a flowchart showing the steps of an insufficient recording agent alert display process of an image forming device according to another embodiment of the present invention.

The aspects of this embodiment that are different from those of the first embodiment will be described below based upon FIG. 3.

In the present embodiment, when a plurality of toners have an insufficient amount remaining for image formation, e.g., when there is a high frequency of use for cyan, magenta, yellow, black in this order, then the display method setting means 4 will rank the toners in this sequence, and display the colors of the toners whose amounts are insufficient. The operation of the image forming device of the present invention will be described below, and will be based on the assumption that the amounts of the magenta and yellow toners remaining are insufficient for image formation.

The cyan sensor 1a will determine whether or not there is an insufficient quantity of cyan toner remaining (S10). If there is an insufficient quantity of cyan toner remaining, this fact will be communicated to the display control means 2, and the display control means 2 will display a cyan color on the LCD display. Note that in the present embodiment, because there is a sufficient quantity of cyan toner remaining, the process will proceed to Step S11.

The magenta sensor 1b will determine whether or not the amount of magenta toner remaining is insufficient (S11). Here, the quantity of magenta toner remaining is insufficient, and thus the magenta sensor 1b will communicate this fact to the display control means 2. The display control means 2 will display a magenta color on the LCD display that corresponds to the insufficient magenta toner (S15).

A user will confirm the display of the magenta color, will perform the task of replenishing the magenta toner, and after this replenishment, the next toner to have an insufficient amount remaining is the yellow toner.

Then, by again performing the determination processes of Steps S10 and S11, the yellow sensor 1c will determine whether or not the amount of yellow toner remaining is insufficient (S12). Here, because the quantity of yellow toner remaining is insufficient, this fact will be communicated to the display control means 2. The display control means 2 will display a yellow color on the LCD display that corresponds to the insufficient yellow toner (S16).

A user will recognize the display of the yellow color, and will perform the task of replenishing the yellow toner. Then, by again sequentially performing the determination processes of Steps S10, S11, and S12, the black sensor 1d will determine whether or not the quantity of black toner remaining is insufficient (S13). When the amount of black toner remaining is insufficient, this fact will be communicated to the display control means 2. The display control means 2 will display a black color on the LCD display (S17), however in the present embodiment, because there is a sufficient quantity of black toner remaining, the process will be complete.

Thus, by ranking and displaying the plurality of color recording agents in accordance with their frequency of use, one can more efficiently replenish the recording agents.

Note that it is also possible for a user to change the ranking order in the display method setting means 4, and thereby make the task of replenishing the recording agents more efficient.

In addition, unlike with the first and second embodiments, when the remaining quantity of a plurality of color recording agents is determined to be insufficient by the recording agent quantity detection means, the display control means may sequentially display each of the plurality of insufficient colors on at least a portion the display means for a predetermined period of time. In this situation, the display setting color will be set in the same way as in the first embodiment, and a plurality of colors will be sequentially displayed in Step S5.

Thus, because the plurality of colors that must be replenished are sequentially displayed, this will be highly visible to the user, and allow the task of replenishing the recording agents to proceed more smoothly.

In addition, the insufficient recording agent alert disclosed in the aforementioned embodiment may be performed by flashing the color of the insufficient recording agents on and off. In this situation, the display setting color may be set in the same way as in the first or second embodiments, and the display setting color set in Step S5 or Step S14 to S17 may be flashed on and off.

In addition, in the first and second embodiments, the color of the insufficient recording agents were displayed on the entirety of the display means 3 (LCD), but the color of the insufficient recording agents may be displayed on a portion of the display means 3 (LCD), e.g., on a “Replenish toner” key, in a guidance message such as “Low toner”, or the like. Furthermore, a key other than on the LCD, such as a print key or 10 key, may display the colors of the insufficient recording agents.

In addition, although the display means was described as a structure which employs an LCD, the display means is not limited thereto, and may be any display means capable of color display.

Furthermore, in the aforementioned embodiment, toner was employed as the recording agent, however the recording agent is not limited to toner in the present invention, and may be ink, recording agents employed in sublimation type image formation, or any other recording agents that are consumed by image formation and which must be replenished.

When the insufficient recording agent is an achromatic color such as black, a color such as gray can be displayed. With chromatic colors such as cyan, yellow, and the like, the display color can be changed to the extent that the color of the recording agent can be identified.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An image forming device, comprising:
a recording agent quantity detection unit that will detect whether there is an insufficient quantity of recording agent for image formation;
a display unit that will notify a user when the recording agent quantity detection unit determines that there is an insufficient quantity of recording agent for image formation; and
a display control unit that will display, on at least a portion of the display unit, a color that corresponds to the color of the recording agent determined to have an insufficient quantity by the recording agent quantity detection unit.

2. The image forming device of claim 1, wherein when the recording agent quantity detection unit detects that there is an insufficient quantity of a plurality of recording agents, the display control unit will display colors that correspond to the colors of the insufficient recording agents on at least a portion of the display unit.

3. The image forming device of claim 1, wherein when the recording agent quantity detection unit detects that there is an insufficient quantity of a plurality of recording agents, the display control unit will sequentially display for a predetermined period of time colors that corresponds to each color of the insufficient recording agents on at least a portion of the display unit.

4. The image forming device of claim 1, wherein when the recording agent quantity detection unit detects that there is an insufficient quantity of a plurality of recording agents, the display control unit will display colors that correspond to each color of the recording agents in a predetermined ranked order on at least a portion of the display unit.

5. The image forming device of claim 4, further comprising a display method setting unit that will changeably set the predetermined ranked order.

6. A storage medium comprising an insufficient recording agent alert program of an image forming device;
the image forming device including a recording agent quantity detection unit that detects whether there is an insufficient quantity of recording agent for image formation, and a display unit that will notify a user when the recording agent quantity detection unit determines that there is an insufficient quantity of recording agent for image formation; and
the insufficient recording agent alert program causing a processor of the image forming device to execute a display control step which displays, on at least a portion of the display unit of the image forming device, a color that corresponds to the color of the recording agent whose quantity was determined to be insufficient in a recording agent quantity detection step.
